(19) United States
(12) Patent Application Publication
(10) Pub. No.: US 2019/0061756 A1
(43) Pub. Date: Feb. 28, 2019

(54) SYSTEM AND METHOD FOR FOLLOWING DISTANCE ADJUSTMENT FOR AN AUTONOMOUS VEHICLE

(71) Applicant: GM GLOBAL TECHNOLOGY OPERATIONS LLC, Detroit, MI (US)

(72) Inventors: Paul A. Adam, Milford, MI (US); Xiaofeng F. Song, Novi, MI (US)

(21) Appl. No.: 15/690,983

(22) Filed: Aug. 30, 2017

(51) Int. Cl. B60W 30/16; B60W 10/04; B60W 10/18; B60W 30/14; B60W 40/04

(52) U.S. Cl. CPC B60W 30/16; B60W 10/04; B60W 10/18; B60W 30/143; B60W 40/04; B60W 2750/30; B60W 2550/30; B60W 2710/09; B60W 2710/18; B60W 2720/106; B60W 2550/14

(57) ABSTRACT

An automotive vehicle includes a propulsion system, at least one wheel brake, a sensor configured to detect objects external to the vehicle, and a controller. The controller is configured to, in response to the sensor detecting a first target vehicle in the path of the host vehicle and a second target vehicle in the path of the host vehicle, automatically control the propulsion system and the at least one wheel brake based on a first relative velocity associated with the first target vehicle, a first relative acceleration associated with the first target vehicle, a second relative velocity associated with the second target vehicle, and a second relative acceleration associated with the second target vehicle.

### TECHNICAL FIELD

The present disclosure relates to vehicles controlled by automated driving systems, particularly those configured to automatically control vehicle acceleration, and braking during a drive cycle without human intervention.

### INTRODUCTION

The operation of modern vehicles is becoming more automated, i.e. able to provide driving control with less and less driver intervention. Vehicle automation has been categorized into numerical levels ranging from Zero, corresponding to no automation with full human control, to Five, corresponding to full automation with no human control. Various automated driver-assistance systems, such as cruise control, adaptive cruise control, and parking assistance systems correspond to lower automation levels, while true “driverless” vehicles correspond to higher automation levels.

### SUMMARY

An automotive vehicle according to the present disclosure includes a propulsion system, at least one wheel brake, a sensor configured to detect objects external to the vehicle, and a controller. The controller is configured to, in response to the sensor detecting a first target vehicle in the path of the host vehicle and a second target vehicle in the path of the host vehicle, automatically control the propulsion system and the at least one wheel brake based on a first relative velocity associated with the first target vehicle, a first relative acceleration associated with the first target vehicle, a second relative velocity associated with the second target vehicle, and a second relative acceleration associated with the second target vehicle.

In an exemplary embodiment, the controller is further configured to automatically control the propulsion system and the at least one wheel brake to a target acceleration based on the lesser of the first relative acceleration and the second relative acceleration. The controller may be further configured to automatically control the propulsion system and the at least one wheel brake to the target acceleration based on current road conditions or on a calibrated initial following distance.

A method of controlling an automotive vehicle according to the present disclosure includes providing the vehicle with a controller programmed to automatically control vehicle acceleration and deceleration and with a sensor arranged to detect objects in the vicinity of the vehicle. The method additionally includes detecting, via the sensor, a first target vehicle in the path of the host vehicle and a second target vehicle in the path of the host vehicle. The method also includes determining a first relative velocity, first relative acceleration, and first relative position associated with the first target vehicle. The method further includes determining a second relative velocity, second relative acceleration, and second relative position associated with the second target vehicle. The method still further includes automatically controlling velocity of the host vehicle, via the controller, in response to the lesser of the first relative velocity and the second relative velocity. The method also includes automatically controlling acceleration of the host vehicle, via the controller, in response to the lesser of the first relative acceleration and the second relative acceleration.

In various exemplary embodiments, the automatically controlling velocity or acceleration of the host vehicle is in further response to a calibrated initial following distance, to a calibrated acceleration limit, to detected road conditions, or to any combination thereof.

An automotive vehicle according to the present disclosure includes a propulsion system, at least one wheel brake, a sensor configured to detect objects external to the vehicle, and a controller. The controller is configured to automatically control the propulsion system and the at least one wheel brake in response to the sensor detecting a first target vehicle in the path of the host vehicle and a second target vehicle in the path of the host vehicle. The automatic control is based on a first calculated time-to-collision parameter associated with the first target vehicle being less than a first associated threshold or a second calculated time-to-collision parameter associated with the second target vehicle being less than a second associated threshold.

In an exemplary embodiment, the controller is configured to calculate the first time-to-collision parameter based on a first relative velocity associated with the first target vehicle, a first relative acceleration associated with the first target vehicle, and a first relative position of the first target vehicle. The controller is also configured to calculate the second time-to-collision parameter based on a second relative velocity associated with the second target vehicle, a second relative acceleration associated with the second target vehicle, and a second relative position associated with the target vehicle.

Embodiments according to the present disclosure provide a number of advantages. For example, the present disclosure provides a system and method for automatically controlling vehicle speed and acceleration to reduce unnecessary heavy acceleration or braking, thereby reducing wear on the vehicle, increasing fuel economy, and increasing customer satisfaction.

The above and other advantages and features of the present disclosure will be apparent from the following detailed description of the preferred embodiments when taken in connection with the accompanying drawings.

### BRIEF DESCRIPTION OF THE DRAWINGS

FIG. 1 is a schematic diagram of a communication system including an autonomously controlled vehicle according to an embodiment of the present disclosure;

FIG. 2 is a schematic block diagram of an automated driving system (ADS) for a vehicle according to an embodiment of the present disclosure;

FIG. 3 is an illustration of a host vehicle according to the present disclosure;

FIG. 4 is a flowchart representation of a method of controlling a vehicle according to first embodiment of the present disclosure; and

FIG. 5 is a flowchart representation of a method of controlling a vehicle according to second embodiment of the present disclosure.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but are merely representative. The various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

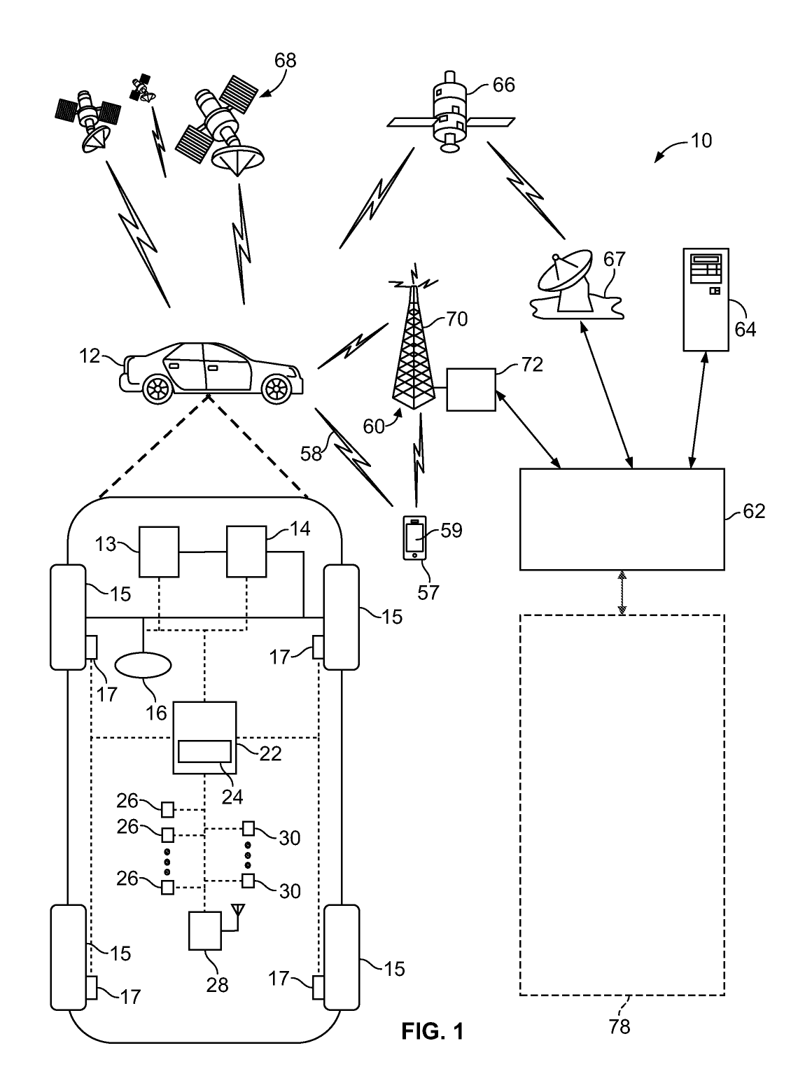

FIG. 1 schematically illustrates an operating environment that comprises a mobile vehicle communication and control system 10 for a motor vehicle 12. The communication and control system 10 for the vehicle 12 generally includes one or more wireless carrier systems 60, a land communications network 62, a computer 64, a mobile device 57 such as a smart phone, and a remote access center 78.

The vehicle 12, shown schematically in FIG. 1, is depicted in the illustrated embodiment as a passenger car, but it should be appreciated that any other vehicle including motorcycles, trucks, sport utility vehicles (SUVs), recreational vehicles (RVs), marine vessels, aircraft, etc., can also be used. The vehicle 12 includes a propulsion system 13, which may in various embodiments include an internal combustion engine, an electric machine such as a traction motor, and/or a fuel cell propulsion system.

The vehicle 12 also includes a transmission 14 configured to transmit power from the propulsion system 13 to a plurality of vehicle wheels 15 according to selectable speed ratios. According to various embodiments, the transmission 14 may include a step-ratio automatic transmission, a continuously-variable transmission, or other appropriate transmission. The vehicle 12 additionally includes wheel brakes 17 configured to provide braking torque to the vehicle wheels 15. The wheel brakes 17 may, in various embodiments, include friction brakes, a regenerative braking system such as an electric machine, and/or other appropriate braking systems.

The vehicle 12 additionally includes a steering system 16. While depicted as including a steering wheel for illustrative purposes, in some embodiments contemplated within the scope of the present disclosure, the steering system 16 may not include a steering wheel.

The vehicle 12 includes a wireless communications system 28 configured to wirelessly communicate with other vehicles (“V2V”) and/or infrastructure (“V2I”). In an exemplary embodiment, the wireless communication system 28 is configured to communicate via a dedicated short-range communications (DSRC) channel. DSRC channels refer to one-way or two-way short-range to medium-range wireless communication channels specifically designed for automotive use and a corresponding set of protocols and standards. However, additional or alternate wireless communications standards, such as IEEE 802.11 and cellular data communication, are also considered within the scope of the present disclosure.

The propulsion system 13, transmission 14, steering system 16, and wheel brakes 17 are in communication with or under the control of at least one controller 22. While depicted as a single unit for illustrative purposes, the controller 22 may additionally include one or more other controllers, collectively referred to as a “controller.” The controller 22 may include a microprocessor or central processing unit (CPU) in communication with various types of computer readable storage devices or media. Computer readable storage devices or media may include volatile and nonvolatile storage in read-only memory (ROM), random-access memory (RAM), and keep-alive memory (KAM), for example. KAM is a persistent or non-volatile memory that may be used to store various operating variables while the CPU is powered down. Computer-readable storage devices or media may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 22 in controlling the vehicle.

The controller 22 includes an automated driving system (ADS) 24 for automatically controlling various actuators in the vehicle. In an exemplary embodiment, the ADS 24 is a so-called Level Four or Level Five automation system. A Level Four system indicates “high automation”, referring to the driving mode-specific performance by an automated driving system of all aspects of the dynamic driving task, even if a human driver does not respond appropriately to a request to intervene. A Level Five system indicates “full automation”, referring to the full-time performance by an automated driving system of all aspects of the dynamic driving task under all roadway and environmental conditions that can be managed by a human driver. However, aspects of the present disclosure may be embodied in a so-called Level Two or Level Three automation system. A Level Two system indicates “partial automation”, referring to the driving-mode specific execution by one or more driver assistance systems of both steering and acceleration/deceleration with the expectation that the human driver perform all remaining aspects of the dynamic driving task. A Level Three system indicates “conditional automation”, referring to the driving mode-specific performance by an automated driving system of all aspects of the dynamic driving task with the expectation that the human driver will respond appropriately to a request to intervene.

In an exemplary embodiment, the ADS 24 is configured to control the propulsion system 13, transmission 14, steering system 16, and wheel brakes 17 to control vehicle acceleration, steering, and braking, respectively, without human intervention via a plurality of actuators 30 in response to inputs from a plurality of sensors 26, which may include GPS, RADAR, LIDAR, optical cameras, thermal cameras, ultrasonic sensors, and/or additional sensors as appropriate.

FIG. 1 illustrates several networked devices that can communicate with the wireless communication system 28 of the vehicle 12. One of the networked devices that can communicate with the vehicle 12 via the wireless communication system 28 is the mobile device 57. The mobile device 57 can include computer processing capability, a transceiver capable of communicating using a short-range wireless protocol, and a visual smart phone display 59. The computer processing capability includes a microprocessor in the form of a programmable device that includes one or more instructions stored in an internal memory structure and applied to receive binary input to create binary output. In some embodiments, the mobile device 57 includes a GPS module capable of receiving GPS satellite signals and generating GPS coordinates based on those signals. In other embodiments, the mobile device 57 includes cellular communications functionality such that the mobile device 57 carries out voice and/or data communications over the wireless carrier system 60 using one or more cellular communications protocols, as are discussed herein. The visual smart phone display 59 may also include a touch-screen graphical user interface.

The wireless carrier system 60 is preferably a cellular telephone system that includes a plurality of cell towers 70 (only one shown), one or more mobile switching centers (MSCs) 72, as well as any other networking components required to connect the wireless carrier system 60 with the land communications network 62. Each cell tower 70 includes sending and receiving antennas and a base station, with the base stations from different cell towers being connected to the MSC 72 either directly or via intermediary equipment such as a base station controller. The wireless carrier system 60 can implement any suitable communications technology, including for example, analog technologies such as AMPS, or digital technologies such as CDMA (e.g., CDMA2000) or GSM/GPRS. Other cell tower/base station/MSC arrangements are possible and could be used with the wireless carrier system 60. For example, the base station and cell tower could be co-located at the same site or they could be remotely located from one another, each base station could be responsible for a single cell tower or a single base station could service various cell towers, or various base stations could be coupled to a single MSC, to name but a few of the possible arrangements.

Apart from using the wireless carrier system 60, a second wireless carrier system in the form of satellite communication can be used to provide uni-directional or bi-directional communication with the vehicle 12. This can be done using one or more communication satellites 66 and an uplink transmitting station 67. Uni-directional communication can include, for example, satellite radio services, wherein programming content (news, music, etc.) is received by the transmitting station 67, packaged for upload, and then sent to the satellite 66, which broadcasts the programming to subscribers. Bi-directional communication can include, for example, satellite telephony services using the satellite 66 to relay telephone communications between the vehicle 12 and the station 67. The satellite telephony can be utilized either in addition to or in lieu of the wireless carrier system 60.

The land network 62 may be a conventional land-based telecommunications network connected to one or more landline telephones and connects the wireless carrier system 60 to the remote access center 78. For example, the land network 62 may include a public switched telephone network (PSTN) such as that used to provide hardwired telephony, packet-switched data communications, and the Internet infrastructure. One or more segments of the land network 62 could be implemented through the use of a standard wired network, a fiber or other optical network, a cable network, power lines, other wireless networks such as wireless local area networks (WLANs), or networks providing broadband wireless access (BWA), or any combination thereof. Furthermore, the remote access center 78 need not be connected via land network 62, but could include wireless telephony equipment so that it can communicate directly with a wireless network, such as the wireless carrier system 60.

While shown in FIG. 1 as a single device, the computer 64 may include a number of computers accessible via a private or public network such as the Internet. Each computer 64 can be used for one or more purposes. In an exemplary embodiment, the computer 64 may be configured as a web server accessible by the vehicle 12 via the wireless communication system 28 and the wireless carrier 60. Other computers 64 can include, for example: a service center computer where diagnostic information and other vehicle data can be uploaded from the vehicle via the wireless communication system 28 or a third party repository to or from which vehicle data or other information is provided, whether by communicating with the vehicle 12, the remote access center 78, the mobile device 57, or some combination of these. The computer 64 can maintain a searchable database and database management system that permits entry, removal, and modification of data as well as the receipt of requests to locate data within the database. The computer 64 can also be used for providing Internet connectivity such as DNS services or as a network address server that uses DHCP or other suitable protocol to assign an IP address to the vehicle 12. The computer 64 may be in communication with at least one supplemental vehicle in addition to the vehicle 12. The vehicle 12 and any supplemental vehicles may be collectively referred to as a fleet.

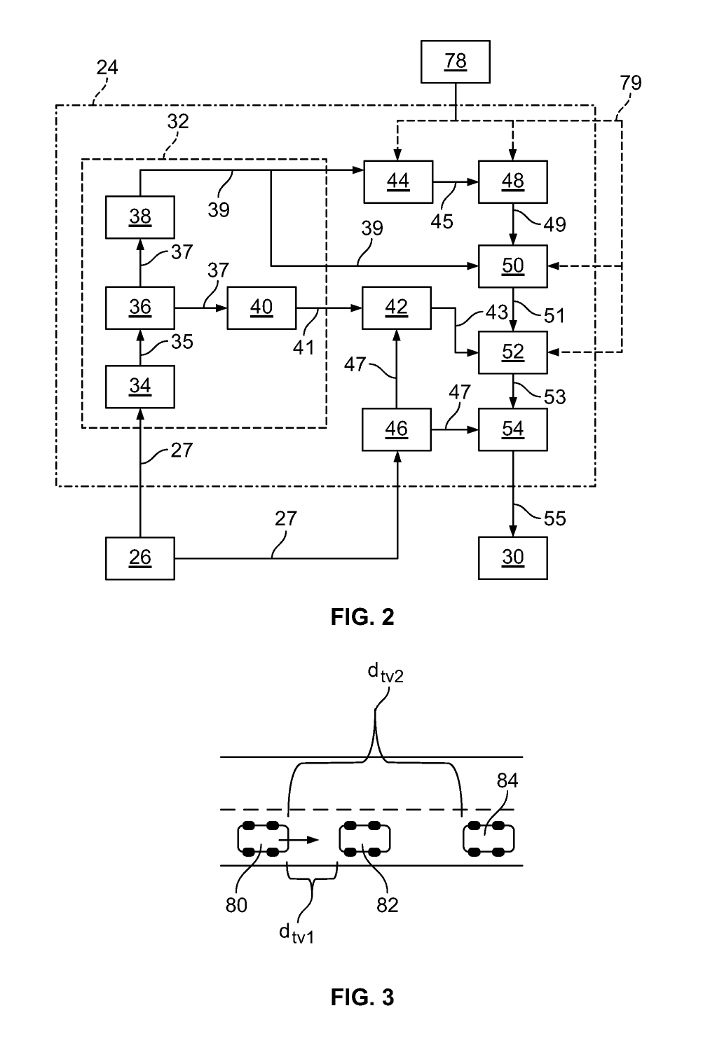

As shown in FIG. 2, the ADS 24 includes multiple distinct control systems, including at least a perception system 32 for determining the presence, location, classification, and path of detected features or objects in the vicinity of the vehicle. The perception system 32 is configured to receive inputs from a variety of sensors, such as the sensors 26 illustrated in FIG. 1, and synthesize and process the sensor inputs to generate parameters used as inputs for other control algorithms of the ADS 24.

The perception system 32 includes a sensor fusion and preprocessing module 34 that processes and synthesizes sensor data 27 from the variety of sensors 26. The sensor fusion and preprocessing module 34 performs calibration of the sensor data 27, including, but not limited to, LIDAR to LIDAR calibration, camera to LIDAR calibration, LIDAR to chassis calibration, and LIDAR beam intensity calibration. The sensor fusion and preprocessing module 34 outputs preprocessed sensor output 35.

A classification and segmentation module 36 receives the preprocessed sensor output 35 and performs object classification, image classification, traffic light classification, object segmentation, ground segmentation, and object tracking processes. Object classification includes, but is not limited to, identifying and classifying objects in the surrounding environment including identification and classification of traffic signals and signs, RADAR fusion and tracking to account for the sensor's placement and field of view (FOV), and false positive rejection via LIDAR fusion to eliminate the many false positives that exist in an urban environment, such as, for example, manhole covers, bridges, overhead trees or light poles, and other obstacles with a high RADAR cross section but which do not affect the ability of the vehicle to travel along its path. Additional object classification and tracking processes performed by the classification and segmentation model 36 include, but are not limited to, freespace detection and high level tracking that fuses data from RADAR tracks, LIDAR segmentation, LIDAR classification, image classification, object shape fit models, semantic information, motion prediction, raster maps, static obstacle maps, and other sources to produce high quality object tracks. The classification and segmentation module 36 additionally performs traffic control device classification and traffic control device fusion with lane association and traffic control device behavior models. The classification and segmentation module 36 generates an object classification and segmentation output 37 that includes object identification information.

A localization and mapping module 40 uses the object classification and segmentation output 37 to calculate parameters including, but not limited to, estimates of the position and orientation of vehicle 12 in both typical and challenging driving scenarios. These challenging driving scenarios include, but are not limited to, dynamic environments with many cars (e.g., dense traffic), environments with large scale obstructions (e.g., roadwork or construction sites), hills, multi-lane roads, single lane roads, a variety of road markings and buildings or lack thereof (e.g., residential vs. business districts), and bridges and overpasses (both above and below a current road segment of the vehicle).

The localization and mapping module 40 also incorporates new data collected as a result of expanded map areas obtained via onboard mapping functions performed by the vehicle 12 during operation and mapping data “pushed” to the vehicle 12 via the wireless communication system 28. The localization and mapping module 40 updates previous map data with the new information (e.g., new lane markings, new building structures, addition or removal of constructions zones, etc.) while leaving unaffected map regions unmodified. Examples of map data that may be generated or updated include, but are not limited to, yield line categorization, lane boundary generation, lane connection, classification of minor and major roads, classification of left and right turns, and intersection lane creation. The localization and mapping module 40 generates a localization and mapping output 41 that includes the position and orientation of the vehicle 12 with respect to detected obstacles and road features.

A vehicle odometry module 46 receives data 27 from the vehicle sensors 26 and generates a vehicle odometry output 47 which includes, for example, vehicle heading and velocity information. An absolute positioning module 42 receives the localization and mapping output 41 and the vehicle odometry information 47 and generates a vehicle location output 43 that is used in separate calculations as discussed below.

An object prediction module 38 uses the object classification and segmentation output 37 to generate parameters including, but not limited to, a location of a detected obstacle relative to the vehicle, a predicted path of the detected obstacle relative to the vehicle, and a location and orientation of traffic lanes relative to the vehicle. Data on the predicted path of objects (including pedestrians, surrounding vehicles, and other moving objects) is output as an object prediction output 39 and is used in separate calculations as discussed below.

The ADS 24 also includes an observation module 44 and an interpretation module 48. The observation module 44 generates an observation output 45 received by the interpretation module 48. The observation module 44 and the interpretation module 48 allow access by the remote access center 78. The interpretation module 48 generates an interpreted output 49 that includes additional input provided by the remote access center 78, if any.

A path planning module 50 processes and synthesizes the object prediction output 39, the interpreted output 49, and additional routing information 79 received from an online database or the remote access center 78 to determine a vehicle path to be followed to maintain the vehicle on the desired route while obeying traffic laws and avoiding any detected obstacles. The path planning module 50 employs algorithms configured to avoid any detected obstacles in the vicinity of the vehicle, maintain the vehicle in a current traffic lane, and maintain the vehicle on the desired route. The path planning module 50 outputs the vehicle path information as path planning output 51. The path planning output 51 includes a commanded vehicle path based on the vehicle route, vehicle location relative to the route, location and orientation of traffic lanes, and the presence and path of any detected obstacles.

A first control module 52 processes and synthesizes the path planning output 51 and the vehicle location output 43 to generate a first control output 53. The first control module 52 also incorporates the routing information 79 provided by the remote access center 78 in the case of a remote take-over mode of operation of the vehicle.

A vehicle control module 54 receives the first control output 53 as well as velocity and heading information 47 received from vehicle odometry 46 and generates vehicle control output 55. The vehicle control output 55 includes a set of actuator commands to achieve the commanded path from the vehicle control module 54, including, but not limited to, a steering command, a shift command, a throttle command, and a brake command.

The vehicle control output 55 is communicated to actuators 30. In an exemplary embodiment, the actuators 30 include a steering control, a shifter control, a throttle control, and a brake control. The steering control may, for example, control a steering system 16 as illustrated in FIG. 1. The shifter control may, for example, control a transmission 14 as illustrated in FIG. 1. The throttle control may, for example, control a propulsion system 13 as illustrated in FIG. 1. The brake control may, for example, control wheel brakes 17 as illustrated in FIG. 1.

While the exemplary embodiment of FIG. 2 illustrates a Level Four or Level Five automated driving system, other embodiments according to the present disclosure may include Level Two or Level Three automated driving systems. Such automated driving systems may have system architectures other than as illustrated in FIG. 2.

Known automated driving systems, including adaptive cruise control systems, determine braking and acceleration requirements based on a so-called closest-in-path vehicle. Stated differently, such systems detect a nearest target vehicle in the current path of the host vehicle, and determine a relative location, relative velocity, and relative acceleration of the target vehicle. The relative location, relative velocity, and relative acceleration parameters are then used to determine acceleration and velocity requirements for the host vehicle.

However, in some traffic conditions, determining acceleration and velocity for the host vehicle based on the closest-in-path vehicle may result in undesirable behavior. As an example, in stop-and-go traffic a so-called accordion effect may occur, in which vehicles alternatively accelerate and decelerate rapidly, resulting in a propagating motion in a stream of traffic. Determining acceleration and velocity based only on the closest-in-path vehicle may perpetuate or exacerbate such an accordion effect, as it could result in the host vehicle mimicking the acceleration and deceleration behavior of the closest-in-path vehicle. Likewise, if the operator of the closest-in-path vehicle is displaying undesirable or distracted driving behavior, determining acceleration and velocity for the host vehicle based on the closest-in-path vehicle could result in the host vehicle mimicking the undesirable acceleration or deceleration behavior.

Referring now to FIG. 3, a host vehicle 80 is provided with an automated driving system configured to control vehicle acceleration and braking in the absence of human input. The host vehicle 80 may have a Level Two autonomous system, such as an adaptive cruise control system, or a higher level of autonomous driving system such as those discussed above.

The host vehicle 80 is configured to detect the presence and location of a first target vehicle 82 and a second target vehicle 84. Both the first target vehicle 82 and the second target vehicle 84 are within the path of the host vehicle 80, with the second target vehicle 84 being ahead of the first target vehicle 82.

The host vehicle 80 is configured to detect a distance to the first target vehicle dₜᵥ₁, a velocity of the first target vehicle vₜᵥ₁, an acceleration of the first target vehicle aₜᵥ₁, a distance to the second target vehicle dₜᵥ₂, a velocity of the second target vehicle vₜᵥ₂, and an acceleration of the second target vehicle aₜᵥ₂, as will be discussed in further detail below. The host vehicle 80 is configured to determine acceleration and velocity requirements for the host vehicle by arbitrating between the detected parameters associated with the first target vehicle 82 and the second target vehicle 84.

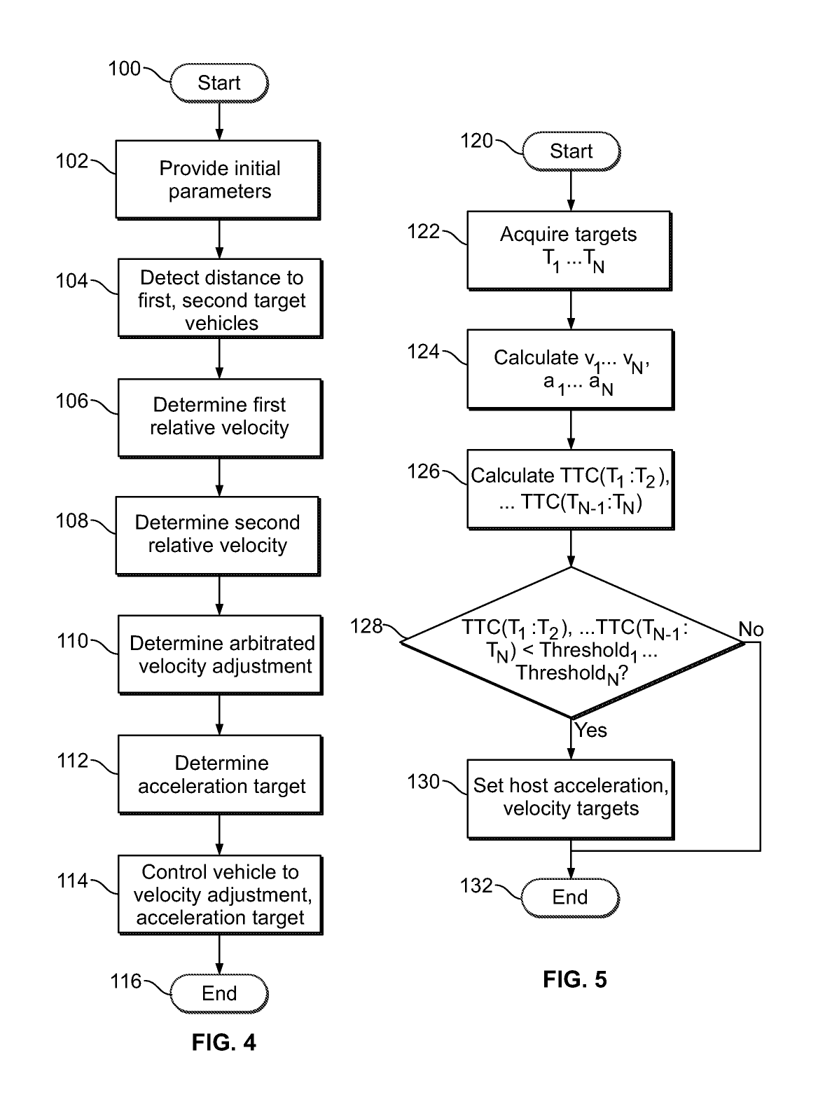

Referring now to FIG. 4, a method of controlling a vehicle according to the present disclosure is illustrated in flowchart form. The algorithm begins at block 100 with the host vehicle under the control of the automated driving system.

An initial set gap ds, an initial set speed vₛ, and a maximum acceleration threshold aₘₐₓ are provided, as illustrated at block 102. The initial set gap refers to a target following distance between the host vehicle and a nearest vehicle in the path of the host vehicle. The initial set gap may be determined, for example, based on a default value provided by a manufacturer, or may be a user-definable value. The initial set speed refers to a target speed for the host vehicle to maintain. The initial set speed may be determined, for example, based on a local speed limit if available, or may be a user-definable value. The maximum acceleration threshold refers to a maximum acceleration value permissible under the control of the automated driving system. The maximum acceleration threshold may be determined, for example, based on a default value provided by a manufacturer, or may be a user-definable value. The maximum acceleration threshold may comprise a first threshold for positive acceleration, e.g. throttle events, and a second threshold for negative acceleration, e.g. braking events.

The host vehicle detects a first target vehicle and a second target vehicle, as illustrated at block 104. The first target vehicle 82 and the second target vehicle are within the path of the host vehicle, with the second target vehicle being ahead of the first target vehicle, e.g. generally as illustrated in FIG. 3. A first distance to the first target vehicle dₜᵥ₁ and a distance to the second target vehicle dₜᵥ₂ are determined, e.g. by radar, LiDAR, optical camera, or other appropriate sensors.

A first relative velocity parameter of the first target vehicle vₜᵥ₁ is calculated, as illustrated at block 106. The first relative velocity parameter is indicative of a velocity difference between the first target vehicle and the host vehicle. In an exemplary embodiment, the first relative velocity parameter is calculated according to the equation:

$$Δ {v}_{hv , tv 1} = \frac{{d}_{tv 1} - {d}_{s}}{Δ t}$$

A second relative velocity parameter of the second target vehicle vₜᵥ₂ is calculated, as illustrated at block 108. The second relative velocity parameter is indicative of a velocity difference between the second target vehicle and the host vehicle. In an exemplary embodiment, the second velocity parameter is calculated according to the equation:

$$Δ {v}_{hv , tv 2} = \frac{{d}_{tv 1} + {d}_{tv 2} - 2 {d}_{s}}{Δ t}$$

An arbitrated velocity adjustment for the host vehicle is determined, accounting for the respective relative velocities of both the first and second target vehicles, as illustrated at block 110. The arbitrated velocity adjustment refers to a target change in velocity relative to a current speed of the host vehicle vₕᵥ. In an exemplary embodiment, the arbitrated velocity adjustment is calculated according to the equation:

Δv_{hv,final}=min[Δv_{hv,tv1},Δv_{hv,tv2}vₛ−vₕᵥ]

Based on the arbitrated velocity adjustment, an acceleration target for the host vehicle is determined, as illustrated at block 112. In an exemplary embodiment, the acceleration target is calculated according to the equation:

$${a}_{hv , final} = min [ \frac{Δ {v}_{hv , final}}{Δ t} , {a}_{max} ]$$

The automated driving system then automatically controls vehicle acceleration according to the acceleration target a_{hv,final} to achieve the arbitrated velocity adjustment Δv_{hv,final}, as illustrated at block 114. The algorithm ends at block 116. The algorithm may be performed on a cyclic basis to provide regular updates to the acceleration target and arbitrated velocity adjustment according to current conditions.

While the above has been described with respect to two target vehicles in the path of the host vehicle for illustrative purposes, the algorithm can easily be generalized to a larger number of target vehicles, as will be understood by one of ordinary skill in the art and discussed further below.

Referring now to FIG. 5, another method according to an embodiment of the present disclosure is illustrated in flowchart form. The algorithm begins at block 120.

A number N of target vehicles is acquired, as illustrated at block 122. The N target vehicles may be acquired using any appropriate sensor system capable of identifying individual external objects, including, but not limited to, optical cameras, RADAR arrays, LiDAR arrays, and ultrasonic sensors. As used here, N is an arbitrary number referring to the quantity of target vehicles detected within range of one or more sensor systems of the host vehicle.

Velocity and acceleration parameters for the N target vehicles are calculated, as illustrated at block 124. These may be calculated, for example, using the equations discussed above with respect to FIG. 4. In an exemplary embodiment, these calculations are performed as part of a sensor fusion algorithm for tracking external objects, e.g. by the sensor fusion and preprocessing module 34 illustrated in FIG. 2.

A time to collision parameter is calculated for each of the N target vehicles, as illustrated at block 126. The time to collision refers to a predicted elapsed time until the host vehicle collides with a respective target vehicle among the N target vehicles, if host vehicle speed and acceleration and target vehicle speed and acceleration remain constant. The time to collision may be determined by a dynamic algorithm, e.g. as part of one of the various modules illustrated in FIG. 2.

A determination is made of whether the calculated time to collision parameter for each of the N target vehicles is less than an associated threshold, as illustrated at operation 128. In an exemplary embodiment, each respective threshold is dynamically calculated based on factors which may include, but are not limited to, road curvature, road congestion, traction, current host vehicle speed, set speed, and relative velocity between the host vehicle and the respective target vehicle.

If the determination of operation 128 is positive, i.e. at least one respective time to collision parameter is less than the associated threshold, then the host vehicle acceleration and velocity are controlled based on the acceleration and velocity of the respective target vehicle, as illustrated at block 130. The algorithm then ends at block 132. Likewise, if the determination of operation 128 is negative, the algorithm ends at block 132.

As may be seen, the present disclosure provides a system and method for automatically controlling vehicle speed and acceleration to reduce unnecessary heavy acceleration or braking, thereby reducing wear on the vehicle, increasing fuel economy, and increasing customer satisfaction.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further exemplary aspects of the present disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. An automotive vehicle comprising:
a propulsion system;
at least one wheel brake;
a sensor configured to detect objects external to the vehicle; and
a controller configured to, in response to the sensor detecting a first target vehicle in the path of the host vehicle and a second target vehicle in the path of the host vehicle, automatically control the propulsion system and the at least one wheel brake based on a first relative velocity associated with the first target vehicle, a first relative acceleration associated with the first target vehicle, a second relative velocity associated with the second target vehicle, and a second relative acceleration associated with the second target vehicle.

2. The automotive vehicle of claim 1, wherein the controller is further configured to automatically control the propulsion system and the at least one wheel brake to a target acceleration based on the lesser of the first relative acceleration and the second relative acceleration.

3. The automotive vehicle of claim 2, wherein the controller is further configured to automatically control the propulsion system and the at least one wheel brake to the target acceleration based on current road conditions.

4. The automotive vehicle of claim 2, wherein the controller is further configured to automatically control the propulsion system and the at least one wheel brake to the target acceleration based on a calibrated initial following distance.

5. A method of controlling an automotive vehicle, comprising:
providing the vehicle with a controller programmed to automatically control vehicle acceleration and deceleration;
providing the vehicle with a sensor arranged to detect objects in the vicinity of the vehicle;
detecting, via the sensor, a first target vehicle in the path of the host vehicle and a second target vehicle in the path of the host vehicle;
determining a first relative velocity, first relative acceleration, and first relative position associated with the first target vehicle;
determining a second relative velocity, second relative acceleration, and second relative position associated with the second target vehicle;
automatically controlling velocity of the host vehicle, via the controller, in response to the lesser of the first relative velocity and the second relative velocity; and
automatically controlling acceleration of the host vehicle, via the controller, in response to the lesser of the first relative acceleration and the second relative acceleration.

6. The method of claim 5, wherein the automatically controlling velocity of the host vehicle is in further response to a calibrated initial following distance.

7. The method of claim 5, wherein the automatically controlling acceleration of the host vehicle is in further response to a calibrated acceleration limit.

8. The method of claim 5, wherein the automatically controlling velocity of the host vehicle is in further response to detected road conditions.

9. An automotive vehicle comprising:
a propulsion system;
at least one wheel brake;
a sensor configured to detect objects external to the vehicle; and
a controller configured to automatically control the propulsion system and the at least one wheel brake in response to the sensor detecting a first target vehicle in the path of the host vehicle and a second target vehicle in the path of the host vehicle, a first calculated time-to-collision parameter associated with the first target vehicle being less than a first associated threshold or a second calculated time-to-collision parameter associated with the second target vehicle being less than a second associated threshold.

10. The automotive vehicle of claim 9, wherein the controller is configured to calculate the first time-to-collision parameter based on a first relative velocity associated with the first target vehicle, a first relative acceleration associated with the first target vehicle, and a first relative position of the first target vehicle, and to calculate the second time-to-collision parameter based on a second relative velocity associated with the second target vehicle, a second relative acceleration associated with the second target vehicle, and a second relative position associated with the target vehicle.

11. The automotive vehicle of claim 10, wherein the controller is further configured to automatically control the propulsion system and the at least one wheel brake to a target acceleration based on the lesser of the first relative acceleration and the second relative acceleration.

12. The automotive vehicle of claim 11, wherein the controller is further configured to automatically control the propulsion system and the at least one wheel brake to the target acceleration based on current road conditions.

13. The automotive vehicle of claim 11, wherein the controller is further configured to automatically control the propulsion system and the at least one wheel brake to the target acceleration based on a calibrated initial following distance.
